(19) United States
(12) Patent Application Publication
(10) Pub. No.: US 2012/0292550 A1
(43) Pub. Date: Nov. 22, 2012

(54) VALVE SEAT AND VALVE

(76) Inventor: Robert K. Meek, Bakersfield, CA (US)

(21) Appl. No.: 13/472,403

(22) Filed: May 15, 2012

Related U.S. Application Data
(60) Provisional application No. 61/486,726, filed on May 16, 2011.

(51) Int. Cl. F16K 25/00

(52) U.S. Cl. 251/359; 251/368

(57) ABSTRACT

A valve including a valve seat having an annular body having a first annular end opposite a second end and an annular groove formed on the first annular end. At least one sealing member is within the groove, and at least a seat face insert is fitted to the sealing member for interfacing with a valve obturator and with the sealing member.

### CROSS-REFERENCE TO RELATED APPLICATION

This application is based upon and claims priority on U.S. Provisional Application No. 61/486,726, filed on May 16, 2011, the contents of which are fully incorporated herein by reference.

### BACKGROUND

The present disclosure relates to a valve seat, in particular to a gate or ball valve seat for use in high pressures and temperatures such as may be encountered in “huff and puff” oil wells or steam injection wells where steam is used in enhanced recovery operations of heavy oil.

Recovery of heavy oil from the producing zones of subterranean formations often requires enhancement techniques in order to dilute or thin the oil. One of these techniques involves the injection of steam, at temperatures on the order of 600° F., into the formation in order to promote thinning of the heavy oil so that it will flow more easily to the well bore where the product is collected and retrieved. Some wells are cycled back and forth from steam injection to production recovery in a process called “huff and puff”. Asphaltene in heavy oil tends to collect on the interior and operating surfaces of associated equipment, including the seats and gates, or balls, of valves, especially when the well is shut in after a production cycle and the equipment cools. This collection often impacts the ability of valves to seal due to build up of asphaltene on sealing surfaces which hardens into a crust-like scale as it cools.

Seats of valves used in the aforementioned application are often provided with elaborate means to allow the seat sealing surface to float so as to remain in contact with the valve gate or ball at all times during operation in an effort to wipe the mating surfaces. These means include the use of springs and sometimes elastomeric products; the latter being a poor choice in high temperature service while the former introduces challenges in sealing, cost, and ease of assembly. Thermoplastic materials such as TFE and PEEK are also sometimes used, but these begin to lose volume at about 450° F. due to out-gassing.

### SUMMARY OF THE DISCLOSURE

In a first aspect, there is provided a valve seat including an annular body having a first annular end opposite a second end and an inner annular surface defining an annulus; an annular groove formed on the first annular end; at least one sealing member within the annular groove; and an annular seat face insert for interfacing with a valve obturator, said seat face insert being adjacent to the at least one sealing member for interfacing with said sealing member and being at least partly within said groove. The valve seat provides a full nominal diameter port through a valve and is capable of enduring high operational temperatures while providing effective sealing against a broad range of pressures and media. The embodiment further accommodates small variations in manufacturing tolerances as well as thermal expansion by providing a floating hard seat face.

In certain embodiments, the sealing member is made from a material that is capable of retaining volume at temperatures greater than 450° Fahrenheit. The valve seat is capable of enduring high operational temperatures for example greater than 450° Fahrenheit.

In certain embodiments, the seat face insert is made from a material selected from the group of materials including cobalt alloys, such as for example Stellite®, tungsten carbide, and combinations thereof.

In other certain embodiments, the at least a sealing member comprises a material selected from the group of materials including carbon graphite yarn, materials comprising graphite, and combinations thereof.

In certain embodiments, the seat face insert comprises a frustoconical section or a wedge for interfacing with the at least a sealing member. The frustoconical or wedge shaped surface on the insert enhances its ability to seal against the sealing member.

In other certain embodiments, the at least a sealing member comprises two sealing members adjacent to each other.

Certain embodiments include at least a groove formed on the second annular end.

Certain embodiments provide a groove formed on the inner annular surface of the annular body forming a lip.

In a second aspect, a valve includes a body having a surface; an annular groove formed on the surface; at least a sealing member within the annular groove; an obturator for blocking and unblocking flow through said valve; and an annular seat face insert for interfacing with the valve obturator, said seat face being adjacent to the at least a sealing member for interfacing with said sealing member and being at least partly within said groove. The valve seat provides a full nominal diameter port through a valve, while providing effective sealing against a broad range of pressures and media. The embodiment further accommodates small variations in manufacturing tolerances as well as thermal expansion by providing a floating hard seat face.

In certain embodiments, the sealing member is made from a material that is capable of retaining volume at temperatures greater than 450° Fahrenheit. The valve seat is capable of enduring high operational temperatures for example greater than 450° Fahrenheit.

In certain embodiments, the seat face insert is made from a material selected from the group of materials including cobalt alloys, such as for example Stellite®, tungsten carbide, and combinations thereof.

In other certain embodiments, the at least a sealing member sealing member a material selected from the group of materials including carbon graphite yarn, materials comprising graphite, and combinations thereof.

In certain embodiments, the seat face insert comprises a frustoconical section or wedge for interfacing with the at least a sealing member. The frustoconical or wedge shaped surface on the insert enhances its ability to seal against the sealing member.

In yet other embodiments, the at least a sealing member comprises two sealing members adjacent to each other.

In a third aspect, an embodiment provides a valve including a valve body; a valve obturator for moving within the valve body for blocking flow and unblocking flow within the body; and at least a valve seat attached to the body, the at least a valve seat comprising, an annular body having a first annular end opposite a second end and an inner annular surface defining an annulus, an annular groove formed on the first annular end, at least a sealing member within the groove, and an annular seat face insert for interfacing with the valve obturator, said seat face insert being adjacent to the at least a sealing member for interfacing with said sealing member and being at least partly within said groove.

In certain embodiments, the sealing member is made from a material that is capable of retaining volume at temperatures greater than 450° Fahrenheit. The valve seat is capable of enduring high operational temperatures for example greater than 450° Fahrenheit.

In certain embodiments, the seat face insert is made from a material selected from the group of materials including cobalt alloys, such as for example Stellite®, tungsten carbide, and combinations thereof.

In other certain embodiments, the at least a sealing member sealing member a material selected from the group of materials including carbon graphite yarn, materials comprising graphite, and combinations thereof.

In certain embodiments, the seat face insert comprises a frustoconical section or a wedge for interfacing with the at least a sealing member. The frustoconical or wedge shaped surface on the insert enhances its ability to seal against the sealing member.

In yet other embodiments, the at least a sealing member comprises two sealing members adjacent to each other.

In certain other embodiments, the at least a valve seat comprises a second valve seat attached to the valve body opposite the first valve seat, the second valve seat including an annular body having a first annular end opposite a second end, an annular groove formed on the first annular end, at least a sealing member within the groove made from a material capable of retaining its volume at temperatures greater than 450° Fahrenheit, and an annular seat face insert for interfacing with the valve obturator opposite said first valve seat, said seat face insert of said second valve seat being over the at least a sealing member of said second valve seat and being at least partly within said groove of said second valve seat.

In certain embodiments, the at least a valve seat further comprises a groove formed on the inner annular surface of the annular body forming a lip.

In other certain embodiments, the at least a valve seat has an interference fit with the valve body.

In certain other embodiments, the at least a valve seat is threaded to the valve body.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is a cross-sectional view of an embodiment of the valve seat.

FIG. 2 is a perspective view of an exemplary embodiment of the valve seat.

FIG. 3 is a partial cross-sectional view of a valve body incorporating an embodiment of the valve seats.

FIG. 4 is an enlarged partial cross-sectional view of section labeled FIG. 4 shown in FIG. 3.

FIG. 5 is a partial cross-sectional view of a section of another embodiment of the valve seat.

### DETAILED DESCRIPTION

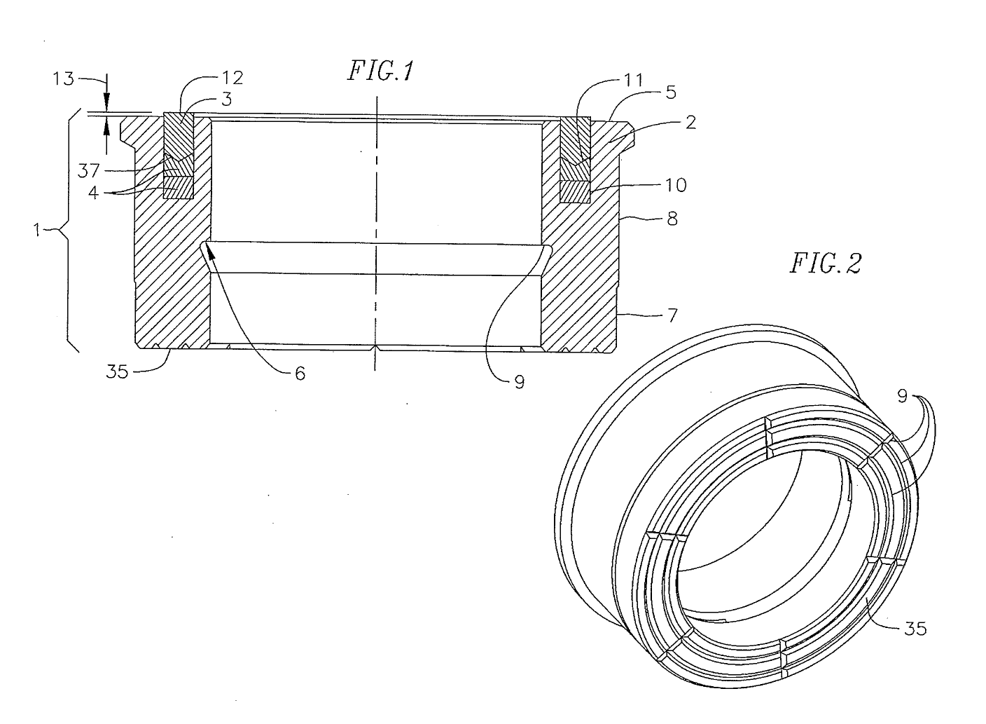

Referring now to the drawings, FIG. 1 and FIG. 2, a representation of a valve seat assembly 1 in accordance with a first embodiment is illustrated.

A valve seat assembly 1 as shown in FIGS. 1 and 2 includes a cylindrical housing 2 (also referred to herein as a seat body) having a first annular end or face 5 (also referred to herein as a “working face”) opposite a second annular end or face 35; an annular (for example, cylindrical) ring 3 (also referred to herein as a “seat face insert”), and one or more annular (for example, cylindrical) sealing members 4 (also referred to herein as “sealing members” or “annular sealing members”), each of which may be a braided rope packing. Each annular sealing member may be a segmented annular sealing member formed from multiple segments which together define an annular member, or maybe a solid annular member. The annular sealing member(s) and the face insert are received within an annular pocket 10 (also referred to herein as an “annular groove”) which is formed on the working face 5. The annular pocket may be formed by precision machining or other methods through the working face 5. It will be recognized by those practiced in the art that there may be differing configurations of valve seat assembly 1, including elements of seat body 2 being integrally provided within a valve body thus eliminating the seat body itself.

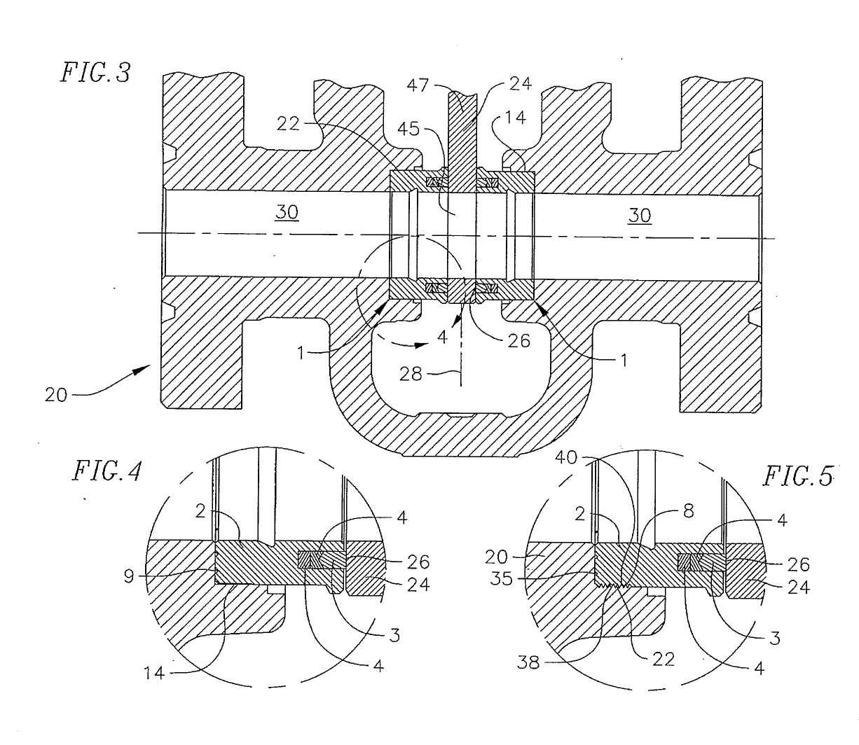

The seat body 2 is an annular (for example, cylindrical) member having an outside diameter or surface 8 designed to have a slight interference fit within a cooperating inside diameter of a pocket 22 machined into a valve body 20, as for example shown in FIGS. 3 and 4. The exemplary embodiment valve body 20 shown in FIGS. 3 and 4 receives two opposing exemplary embodiment seat assemblies 1.

In an exemplary embodiment, the seat body 2 also has a second outside diameter or surface 7, extending from outside surface 8 to the second annular face 35, that has a smaller diameter than the outside surface 8 and that provides a slight volumetric clearance with its corresponding valve body pocket 22 to accommodate high temperature epoxy, or other appropriate adhesive 14 to retain seat body 2 within the valve body pocket and further provide a seal between the valve body pocket 22 and the seat body 2. The reduced diameter surface also serves as a guide for guiding the seat body 2 into the pocket 22 during assembly. In an exemplary embodiment, a plurality of shallow grooves 9 (shown in FIG. 2), which in an exemplary embodiment may be annular and/or radial, are machined or otherwise formed, on the second annular face of seat body 2 in order to allow excess adhesive 14 to escape when the seat body 2 is installed in the cooperating valve body pocket 22. In this regard, the trapped excess adhesive will not cause the seat body 2 to stand up at such height that might cause undesirable interference with a valve obturator 24 during valve assembly and/or operation. An internal groove 6 may be provided at the inside diameter (that is, the inside surface) of seat body 2 to facilitate removal of the seat body from the valve body by providing a lip 9 from which the seat may be pulled for being removed.

In the shown exemplary embodiment, the seat face insert 3 is a floating insert made of a wear resistant material such as a cobalt alloy, including but not limited to cobalt-chromium alloys which may or may not contain tungsten or molybdenum and carbon, such as for example a Stellite® cobalt alloy, tungsten carbide, machinable ceramics, or combinations thereof, that cooperates with the valve obturator 24 to affect the metal to metal seal.

An end surface 37 of seat face insert 3 opposite the working face 12 is, in an exemplary embodiment, a frustoconical surface or a wedge 11 that cooperates with the sealing member(s) 4 to effect a seal between the seat face insert 3, the sealing member(s) 4 and the seat body 2 when a load is applied to the working face 12. The sealing member(s) are made from material(s) that are capable of retaining their integrity at high temperatures, as for example temperatures greater than 450° F. and in some embodiments at temperatures greater than 600° F., in some other embodiments at temperatures greater than 1000° F., and in other embodiments at temperatures greater than 1200° F. These are materials that retain their volume (e.g. they do not out gas) and sealing properties at such temperatures. For example, the sealing member(s) 4 may be a rope type packing having a lattice style braid and made from carbon graphite yarn. Other packing materials, such as preformed graphite packing materials and flexible graphite materials, as for example, Grafoil® may also be used. More than one type of material may be used to form each sealing member. Moreover, sealing members formed from different materials may be used in each application. When a load is applied to the working face 12, the frustoconical surface or wedge 11 forces the sealing member 4 radially outward as well as toward the base of the pocket 10 to seal against any bypass leakage between the seat body 2 and the end surface 37 of the seat face insert 3. The volumes of the pocket 10, the seat face insert 3, and the sealing member(s) 4 are closely controlled so that an operational clearance 13 is maintained between the seat body 2 and the upper face 12 while allowing for thermal expansions and contractions to be accommodated by sealing members 4. In an embodiment, the operational clearance 13 is about 0.010 inch as measured from the working face 5 of the seat face insert 3. When the seat face insert is installed over the sealing members, it projects beyond the working face 5 typically by a distance of about 0.020 inch. However, once it is pressed into the annular pocket 10 and against the sealing member(s), as for example by the obturator, the operational clearance 13 is about 0.010 inch. The outside and inside diameters of the seat face insert 3 have slight operational radial clearances with the annular pocket 10 so as to allow the seat face insert 3 to freely slide in and out of the annular pocket 10. An exemplary radial clearance between the seat face insert 3 and the annular pocket 10 is typically from about 0.002 to about 0.004 inch.

The seat face insert 3 has a working face 12 that is, in an exemplary embodiment, finely machined or ground to cooperate with a valve obturator 24, such as for example a gate or ball obturator, to affect a metal to metal seal 26 with the obturator (FIGS. 3 and 4). A gate obturator is shown in FIG. 4. The gate obturator 24 translates along an axis 28 between the opposing valve seats between a first open position (as shown in FIG. 3) where flow along a passage 30 through the valve body 20 and through a passage 45 in the obturator 24 can occur, to a second position where a solid portion 47 the obturator 24 blocks the flow along the passage 30. When in the first or second position, the obturator 24 interfaces with the working face of each seat face insert 3 such that a seal, for example, a metal to metal seal, is created between each seat face insert 3 and the obturator 24. At the same time, the seat face inserts 3 interface with their corresponding sealing member(s) 4, forming a seal there between.

In another exemplary embodiment, each valve seat assembly includes a seat face insert for interfacing with a ball obturator. A ball obturator rotates, rather than translates, and has a spherical (for example, ball) shaped outer surface with a through passage perpendicular to its axis of rotation. In other words, the ball obturator rotates to a first position about the axis 28 to align its through passage with the passage 30 of the valve body and rotates to a second position such that the body of the obturator blocks the flow through passage 30. With this exemplary embodiment, the working face 12 of each seat face insert is machined along a spherical surface such that the spherical surface of the obturator can be contacted by the entire working face of the seat face insert to create a seal.

In other exemplary embodiments, each valve seat body 2 may be coupled to the valve body 20 with an adhesive 14 with or without having an interference fit with the valve body 20. In such an embodiment, the outer surface 8 of the valve body may extend to the second face 35 of the valve seat. In another exemplary embodiment, each valve seat body 2 may be threaded onto the valve body 20. For example, each valve seat body 2 may have external threads 38 that are threaded to corresponding threads 40 formed on a corresponding inner surface of pocket 22 of the valve body 20 (FIG. 5). The external threads 38 may be formed on the outer surface 7 and/or 8 of the valve seat body 2. In such an exemplary embodiment, the outer surface of the valve seat body 2 may have a constant diameter extending to the second face 35. In other words, the surface 8 may extend to the second face 35, as for example shown in FIG. 5.

In another exemplary embodiment, each valve seat body 2 may be integrally formed with the valve body 20. In such an embodiment, the valve body is formed with annular pockets 10 which receive the sealing member(s) 4 and the seat face insert 3 for interfacing with the valve obturator 24.

The embodiments disclosed above provide a valve seat assembly having seat inserts, which is able to maintain contact with the obturator and provide better sealing at high temperatures as for example, temperatures greater than 450° F., than conventional valve seat assemblies that incorporate thermoplastics or other elastomeric products for exerting a force on the seat inserts against the obturator. In addition, by not requiring springs to provide such a force on the seat inserts, the valve seat assemblies are easier to install and are not prone to the sealing problems that are present when springs are used. The seat valve assemblies of the present invention are capable of enduring high operational temperatures, for example temperatures greater than 450° F., while providing effective sealing against a broad range of pressures and media.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, for example, aspects of one embodiment may be combined with aspects of another embodiment to realize yet other embodiments. Further, each independent feature or component of any given assembly may constitute an additional embodiment.

1. A valve seat comprising:
an annular body having a first annular end opposite a second end and an inner annular surface defining an annulus;
an annular groove formed on the first annular end;
at least one sealing member within the annular groove; and
a seat face insert for interfacing with a valve obturator, said seat face insert being adjacent to the at least one sealing member for interfacing with said sealing member and being at least partly within said annular groove.

2. The valve seat of claim 1, wherein the at least one sealing member is made from a made from a material that is capable of retaining its volume at temperatures greater than 450° Fahrenheit.

3. The valve seat of claim 1, wherein the seat face insert is made from a material selected from the group of materials comprising cobalt alloys, tungsten carbide, and combinations thereof.

4. The valve seat of claim 1, wherein the at least one sealing member comprises a material selected from the group of materials comprising carbon graphite yarn, materials comprising graphite, and combinations thereof.

5. The valve seat of claim 1, wherein the seat face insert comprises a frustoconical section or a wedge for interfacing with the at least one sealing member.

6. The valve seat of claim 1, wherein the at least one sealing member comprises two sealing members adjacent to each other.

7. The valve seat of claim 1, further comprising at least a groove formed on said second annular end.

8. The valve seat of claim 1, further comprising a groove formed on the inner annular surface of the annular body forming a lip.

9. A valve comprising:
a body having a surface;
an annular groove formed on the surface;
at least one sealing member within the groove;
an obturator for blocking and unblocking flow through said valve; and
a seat face insert for interfacing with the valve obturator, said seat face insert being adjacent to the at least one sealing member for interfacing with said sealing member and being at least partly within said annular groove.

10. The valve of claim 9, wherein the at least one sealing member is made from a material that is capable of retaining its volume at temperatures greater than 450° Fahrenheit.

11. The valve of claim 9, wherein the seat face insert is made from a material selected from the group of materials comprising cobalt alloys, tungsten carbide, and combinations thereof.

12. The valve of claim 9, wherein the at least one sealing member comprises a material selected from the group of materials comprising carbon graphite yarn, materials comprising graphite, and combinations thereof.

13. The valve of claims 9, wherein said seat face insert comprises a frustoconical section or wedge for interfacing with the at least one sealing member.

14. The valve of claim 9, wherein the at least one sealing member comprises two sealing members adjacent to each other.

15. A valve comprising:
a valve body;
a valve obturator for moving within the valve body for blocking flow and unblocking flow within the body; and
at least one valve seat attached to the body, the at least one valve seat comprising,
an annular body having a first annular end opposite a second end and an inner annular surface defining an annulus,
an annular groove formed on the first annular end,
at least one sealing member within the groove, and
a seat face insert for interfacing with the valve obturator, said seat face insert being adjacent to the at least one sealing member for interfacing with said sealing member and being at least partly within said annular groove.

16. The valve of claim 15, wherein the at least one sealing member is made from a material capable of retaining its volume at temperatures greater than 450° Fahrenheit.

17. The valve of claim 15, wherein the seat face insert is made from a material selected from the group of materials comprising cobalt alloys, tungsten carbide, and combinations thereof.

18. The valve of claim 15, wherein the at least one sealing member sealing member comprises a material selected from the group of materials comprising carbon graphite yarn, materials comprising graphite, and combinations thereof.

19. The valve of claims 15, wherein said seat face insert comprises a frustoconical section or a wedge for interfacing with the at least one sealing member.

20. The valve of claim 15, wherein the at least one sealing member comprises two sealing members adjacent to each other.

21. The valve of claim 15, wherein the at least one valve seat comprises a second valve seat attached to the valve body opposite the first valve seat, the second valve seat comprising,
an annular body having a first annular end opposite a second end,
an annular groove formed on the first annular end,
at least one sealing member within the groove, and
a seat face insert for interfacing with the valve obturator opposite said first valve seat, said seat face insert of said second valve seat being over the at least one sealing member of said second valve seat and being at least partly within said annular groove of said second valve seat.

22. The valve of claim 21, wherein the at least one sealing member of the second valve seat is made from a material capable of retaining its volume at temperatures greater than 450° Fahrenheit.

23. The valve of claim 15, wherein the at least one valve seat further comprises a groove formed on the inner annular surface of the annular body forming a lip.

24. The valve of claim 15, wherein the at least one valve seat has an interference fit with the valve body.

25. The valve of claim 15, wherein the at least one valve seat is threaded to the valve body.
